(19) United States
(12) Patent Application Publication
(10) Pub. No.: US 2021/0262250 A1
(43) Pub. Date: Aug. 26, 2021

(54) SMART HATCH LOCKING AND VENTILATION SYSTEMS FOR HATCHES WINDOWS AND DOORS

(71) Applicants: James Stranger, Chino, CA (US); Brittany Stone, Chino, CA (US)

(72) Inventors: James Stranger, Chino, CA (US); Brittany Stone, Chino, CA (US)

(21) Appl. No.: 17/181,993

(22) Filed: Feb. 22, 2021

Related U.S. Application Data
(60) Provisional application No. 63/030,294, filed on May 26, 2020.
(60) Provisional application No. 63/026,715, filed on May 18, 2020.
(60) Provisional application No. 62/979,124, filed on Feb. 20, 2020.

(51) Int. Cl. E05B 47/00

(52) U.S. Cl. CPC E05B 47/0012; E05B 2047/0023; E05B 2047/002

(57) ABSTRACT

This application is directed to systems and methods of locking and unlocking a hatch lid or any other type of opening having a hinged covering. In some embodiments, a blade is actuated by a motor or linear actuator. Blades of the inventive subject matter can include one or two racks that interact with one or two pinion gears. In embodiments having rotational motors, a pinion gear can be coupled with that motor and with a rack that can cause the blade to move when the motor turns. In embodiments having linear actuators, the linear actuator more directly causes the blade to move. Other embodiments of the inventive subject matter include a screw mechanism that can interact with a locker receptacle upon rotating a motor coupled thereto.

This application claims priority to U.S. Provisional Patent Application No. 63/030,294 filed May 26, 2020; U.S. Provisional Patent Application No. 63/026,715 filed May 18, 2020; and U.S. Provisional Patent Application No. 62/979,124 filed Feb. 20, 2020. All extrinsic materials identified in this application are incorporated by reference in their entirety.

### FIELD OF THE INVENTION

The field of the invention is locking systems for hatches, doors, windows, and other hinge-based openings.

### BACKGROUND

The background description includes information that may be useful in understanding the present invention. It is not an admission that any of the information provided in this application is prior art or relevant to the presently claimed invention, or that any publication specifically or implicitly referenced is prior art.

Boats, buildings, ships, watercraft, cars, cruise ships, RVs, mobile homes, buses, aircraft, vans, structures, animal enclosures, and all other manner of vehicles and vessels that have an interior space often incorporate hatches or doors that can open an interior space out to the exterior. For example, a boat's cabin can include one or more hatches to, among other things, facilitate airflow and to allow for ingress and egress. Until now, these components have gone largely unchanged, despite many advancements in technology that have brought about smaller, more powerful actuators that require less energy to use, as well as better electronics to facilitate control systems and to allow for wireless communication and control. There exists a need for low energy consuming actuation systems that can facilitate automated locking and unlocking as well as opening and closing.

One example of an effort to improve on existing boat hatches is U.S. Pat. No. 8,688,329 to Cathcart. This patent is directed to a hatch having a linear actuator that can be used to open and close the hatch. But the Cathcart patent fails to contemplate many different improvements that can be implemented using newer technologies, and it similarly fails to contemplate more advanced locking mechanisms.

Examples of improved watercraft hatches are few and far between, but even innovations in other fields, such as car doors, indicate there is ample room for improvement. European Patent Application No. 1087080 is directed to car door systems as opposed to marine door systems. But even this application fails to consider new mechanisms and systems described in this application that can be implemented to cause a door to swing open, and it similarly fails to consider using a variety of different sensors to automate opening and closing of the door.

Thus, there still exists a need in the art for improved hatches for various uses e.g., in watercraft, vehicles, structures, and other applications.

These and all other extrinsic materials discussed in this application are incorporated by reference in their entirety. Where a definition or use of a term in an incorporated reference is inconsistent or contrary to the definition of that term provided in this application, the definition of that term provided in this application applies and the definition of that term in the reference does not apply.

### SUMMARY OF THE INVENTION

The present invention provides apparatus, systems, and methods in which a lateral or rotating blade can be used to lock and unlock a hatch. In one aspect of the inventive subject matter, a lid locking and unlocking system is contemplated. The system includes a locking mechanism configured to couple with the lid, the locking mechanism having: a blade comprising a rack along an edge; a motor coupled with a pinion gear, wherein the pinion gear is configured to interact with the rack such that rotating the pinion gear causes the blade to translate; and a receiving mechanism configured to couple with a base, wherein the lid is hingedly coupled with the base and the receiving mechanism comprises a locker receptacle configured to receive the blade.

In some embodiments, the blade further comprises a second rack along a portion of a second edge of the blade. The system can additionally include an exterior manual actuator disposed on an exterior side of the lid, wherein the exterior manual actuator couples with a second pinion gear that is configured to interact with the second rack.

In some embodiments, the system also includes an interior manual actuator disposed on an interior side of the lid, wherein the interior manual actuator couples with a second pinion gear that is configured to interact with the second rack. In some embodiments, the system also includes an exterior manual actuator disposed on an exterior side of the lid and an interior manual actuator disposed on an interior side of the lid, wherein the exterior manual actuator and the interior manual actuator both couple with a second pinion gear disposed therebetween, wherein the second pinion gear is configured to interact with the second rack.

In some embodiments, the second rack is disposed along a portion of the second edge of the blade such that the second pinion gear becomes disengaged from the second rack upon the locking mechanism entering a locked configuration. The interior manual actuator can include at least one peg that is configured to interact with a slot disposed on a side of the second pinion gear facing the interior manual actuator. In some embodiments, the blade comprises a plunger that can be used to manually translate the blade into and out of a locked configuration.

In another aspect of the inventive subject matter, a lid locking and unlocking system is contemplated. The system includes a locking mechanism configured to couple with the lid, the locking mechanism comprising: a blade comprising a rack along an edge and a second rack along a second edge; a motor coupled with a pinion gear, wherein the pinion gear is configured to interact with the rack such that rotating the pinion gear causes the blade to translate; wherein the blade comprises a sloped portion on an end of the blade; a receiving mechanism configured to couple with a base, wherein the lid is hingedly coupled with the base and the receiving mechanism comprises a locker receptacle configured to receive the sloped portion of the blade; a manual actuation mechanism comprising: an interior manual actuator disposed on an interior side of the lid, wherein the interior manual actuator couples with a second pinion gear that is configured to interact with the second rack; and an exterior manual actuator disposed on an exterior side of the lid, wherein the exterior manual actuator also couples with the second pinion gear.

In some embodiments, the interior manual actuator comprises at least one peg that is configured to interact with a slot disposed on a side of the second pinion gear facing the interior manual actuator. In some embodiments, the second rack is disposed along a portion of the second edge of the blade such that the second pinion gear becomes disengaged from the second rack upon the locking mechanism entering a locked configuration. In some embodiments, the blade comprises a plunger that can be used to manually translate the blade into and out of a locked configuration.

In another aspect of the inventive subject matter, a lid locking and unlocking system is contemplated, the system comprising a locking mechanism configured to couple with the lid, the locking mechanism comprising: a blade; a linear actuator coupled with the blade, wherein actuating the linear actuator causes the blade to translate; and a receiving mechanism configured to couple with a base, wherein the lid is hingedly coupled with the base and the receiving mechanism comprises a locker receptacle configured to receive the sloped portion of the blade.

In some embodiments, the blade further comprises a rack along a portion of an edge of the blade. The system can additionally include an exterior manual actuator disposed on an exterior side of the lid, where the exterior manual actuator couples with a pinion gear that is configured to interact with the rack. In some embodiments, the system also includes an interior manual actuator disposed on an interior side of the lid, where the interior manual actuator couples with a pinion gear that is configured to interact with the rack.

The system can also include an exterior manual actuator disposed on an exterior side of the lid and an interior manual actuator disposed on an interior side of the lid, wherein the exterior manual actuator and the interior manual actuator both couple with a pinion gear disposed therebetween, wherein the pinion gear is configured to interact with the rack. In some embodiments, the pinion gear becomes disengaged from the rack upon the locking mechanism entering a locked configuration. In some embodiments, the interior manual actuator comprises at least one peg that is configured to interact with a slot or hole disposed on a side of the pinion gear facing the interior manual actuator.

In another aspect of the inventive subject matter, a lid locking and unlocking system is contemplated, the system has a locking mechanism configured to couple with the lid, the locking mechanism comprising: a screw mechanism; a motor coupled with the screw mechanism, wherein actuating the motor causes the screw mechanism to rotate; a receiving mechanism configured to couple with a base, wherein the lid is hingedly coupled with the base and the receiving mechanism comprises a locker receptacle configured to receive the screw mechanism.

In some embodiments, the system also includes an exterior manual actuator disposed on an exterior side of the lid, wherein the exterior manual actuator is configured to couple with the screw mechanism.

One should appreciate that the disclosed subject matter provides many advantageous technical effects including autonomous operation of the hatches locking mechanism to allow interior spaces to be connected or closed in terms of ventilation, lighting, humidity or presence of water while also possible to operate the mechanism manually, from a mobile device, remote control device, control panel, or controls directly mounted to the system. This flexibility of usability also facilitates improved safety and reliability of the hatches, preventing possible damage to the interior space or its contents.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a front, cutaway view of a system of the inventive subject matter in an unlocked configuration.

FIG. 2 is a side, cutaway view thereof.

FIG. 3 is a top, cutaway view thereof in a locked configuration.

FIG. 4 is a top, cutaway view thereof in an unlocked configuration.

FIG. 5 shows manual actuation mechanisms.

FIG. 6 shows a top, cutaway view of a locking system featuring a linear actuator in a locked configuration.

FIG. 7 shows a top, cutaway view thereof in an unlocked configuration.

FIG. 8A shows a top view of a locking system having a screw mechanism.

FIG. 8B shows the locking system of FIG. 8A with a locking mechanism disengaged.

FIG. 9A shows a side, cutaway view of FIG. 8A.

FIG. 9B shows a side, cutaway view of FIG. 9A.

FIG. 10 shows a side view of a locking mechanism in a locked configuration and featuring a locking tab.

FIG. 11 shows a side view thereof in an unlocked configuration.

FIG. 12 shows a side view of a locking mechanism in another locked configuration.

FIG. 13 shows a side view of a locking mechanism in another locked configuration.

FIG. 14 shows a side view of a locking mechanism in another locked configuration with its blade interacting with a locker receptacle such that there is no watertight seal between lid and base.

FIG. 15 shows a side view of a locking mechanism in another locked configuration with its blade interacting with a locker receptacle.

FIG. 16 shows a side view of a locking mechanism in another locked configuration with its blade interacting with a locker receptacle.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

Embodiments of the inventive subject matter can be incorporated into hatches on boats and other watercraft. Although the examples below can be interpreted as pertaining specifically to boats and other watercraft, the inventors specifically contemplate implementing embodiments into any manner of buildings, structures, equipment, mining facilities, aircraft, vessels, and vehicles that have opening doors or windows that could benefit from automated and electronic control. For example, in the context of a building, skylights in many homes are difficult to reach and would benefit from a system that allows for both remote control and for automated control based on, e.g., environmental conditions and user preferences. As such, in this application, the term “lid” without a modifier preceding it (e.g., “hatch lid”) should be interpreted to refer to a hinged cover of an opening, where that opening can be a door, a window, a hatch, etc.

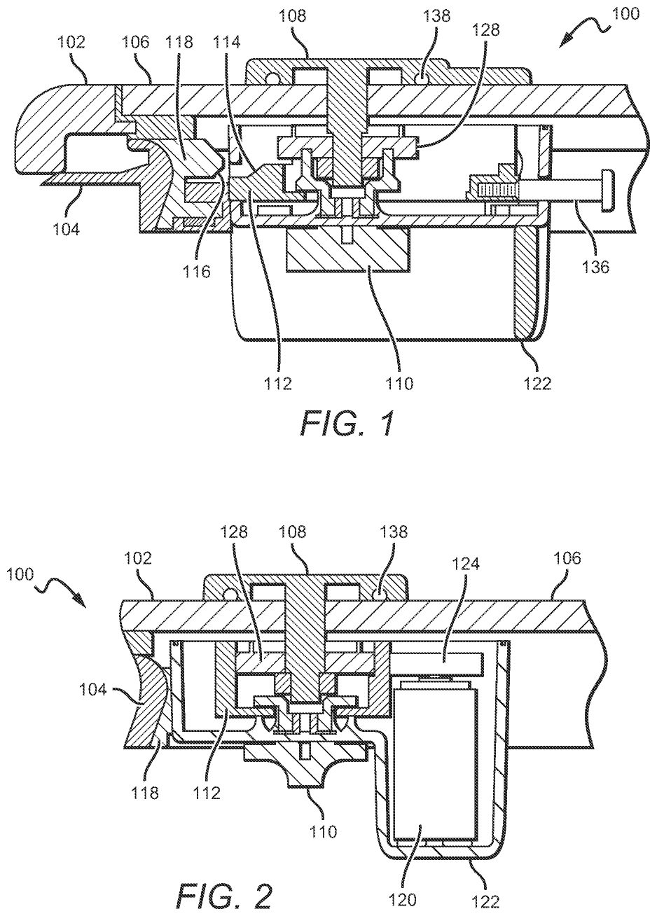

FIG. 1 shows a front view of a locking system 100, and FIG. 2 shows a side view of the same. Locking system 100 is a manually or electronically actuated locking mechanism that is shown incorporated into a hatch having a hatch lid 102 that is hingedly coupled with a hatch base 104. Hatch lid 102 features a plate portion 106 (e.g., made from acrylic, glass, metal, wood, plastic, composites, or the like). Plate portion 106 is the flat part of the hatch lid 102, which can be transparent to allow light to the interior side of hatch lid 102.

Locking system 100 is configured such that at least a portion passes through plate portion 106. This allows for an exterior handle 108 to be accessible on an exterior side of hatch lid 102 while other portions are disposed on an interior side of hatch lid 102. Locking system 100 is configured for both manual and electronic actuation, where the actuation can actuate system 100 into several different configurations including locked (external handle 108 and knob 110 are disengaged), unlocked (external handle 108 and knob 110 are engaged), closed (locking blade 112 is fully extended), and open (locking blade 112 is fully retracted). In the locked configuration, the lid can be either watertight or non-watertight, depending on how far the locking blade is extended. Because the locking blade has a sloped portion, if the blade is not fully extended into the locker receptable, the lid can be locked by also non-watertight, thus allowing air or water to pass through it, and when the blade is fully extended, it pulls the lid down to create a watertight seal. Thus, in the closed configuration, the lid can be watertight-locked or it can be non-watertight-locked. In the unlocked configuration, the lid is not necessarily watertight (e.g., while unlocked, the lid can be either opened or closed). Actuation can be accomplished manually using internal knob 110 or exterior handle 108. Exterior handle 108 can additionally include an O-ring 138 to help create a watertight seal between exterior handle 108 and hatch lid 102. Both exterior handle and interior knob can be more generally described as exterior and interior manual actuators.

A user can rotate either exterior handle 108 or internal knob 110 to cause locking blade 112 to translate laterally (left/right as shown in FIG. 1), which places locking system 100 in either a locked configuration (where locking blade 112 is translated to the left, as drawn) or an unlocked configuration (where locking blade 112 is translated to the right, as drawn).

Locking blade 112 features a sloped portion 114 on an end, as shown in FIG. 1. Sloped portion 114 is sloped to match a second sloped portion 116 that is part of locker receptacle 118. When locking blade 112 slides to the left, the end of locking blade 112 having sloped portion 114 mates with locker receptacle 118. This action causes locking system 100 to enter a locked configuration, which prevents hatch lid 102 from opening relative to hatch base 104. Sloped portion 114 facilitates proper insertion of locking blade 112 into locker receptacle 118, and when sloped portion 114 interacts a complementary sloped portion of locker receptacle 118, a resulting reaction force presses hatch lid 102 down onto hatch base 104. This downward force creates a watertight seal, especially in embodiments featuring a rubber gasket (e.g., weather strip) between hatch lid 102 and hatch base 104. Locker receptacles of the inventive subject matter can be incorporated into hatch base such that the locking blade (or the screw mechanism discussed below) can interact with that portion of hatch base to lock and unlock the associated lid. In other words, the hatch base can act as the locker receptacle itself. In still further embodiments, locker receptable 118 is not included and the locking blade 112 can interact directly with hatch base 104.

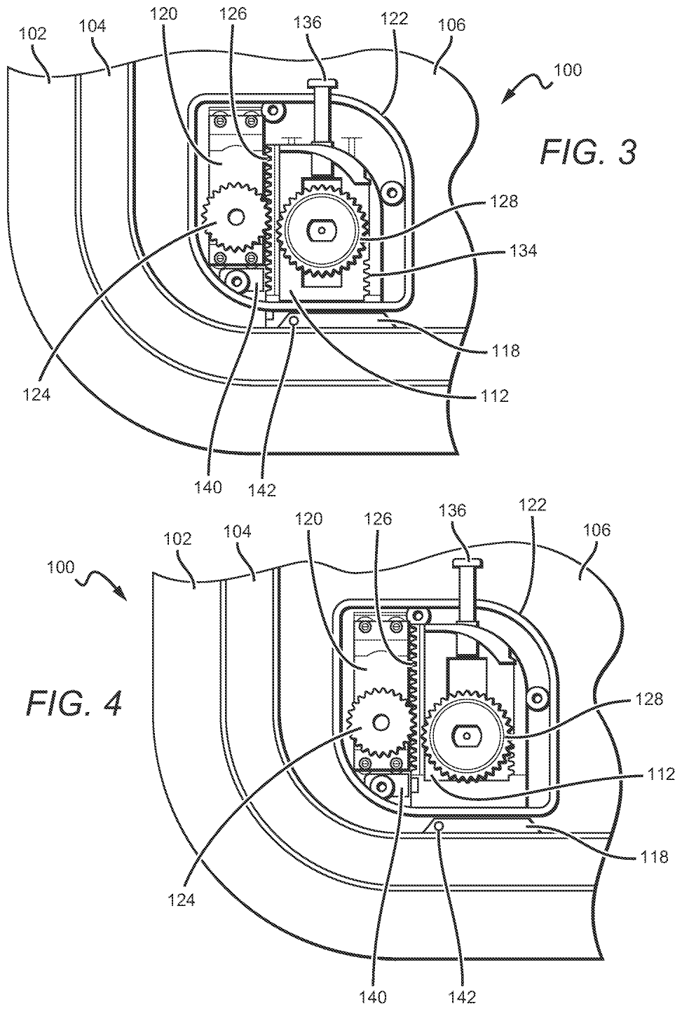

Locking system 100 can also be electronically actuated by, e.g., an electric motor 120, which is housed in handle enclosure 122 and made visible in FIG. 2. Motor 120 has an output that couples with a pinion gear 124. As shown in FIGS. 3 and 4, which show system 100 from the top, pinion gear 124 interacts with rack 126. When pinion gear 124 rotates, it interacts with rack 126, causing rack 126 to translate (up and down, as shown in FIGS. 3 and 4). This translation causes locking blade 112 to move in or out of locker receptacle 118, thereby alternating locking system 100 between a locked configuration (FIG. 3) and an unlocked configuration (FIG. 4).

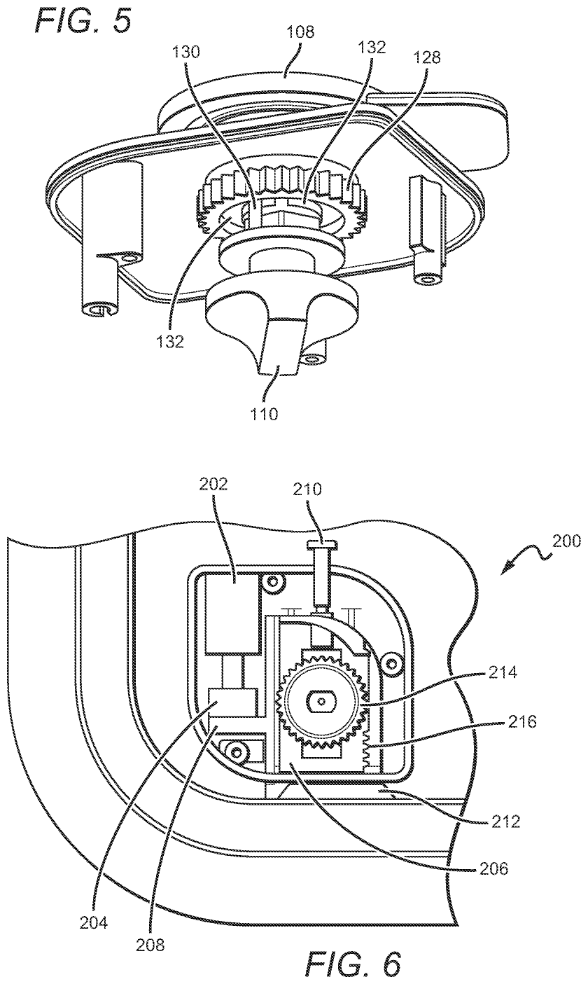

FIGS. 1-4 also show a second pinion gear 128. Second pinion gear 128 is coupled with exterior handle 108 such that turning exterior handle 108 causes second pinion gear 128 to rotate. Internal knob 110 can be either directly or indirectly coupled with second pinion gear 128. FIG. 5 shows how second pinion gear 128 couples with internal knob 110. Internal knob 110 comprises one or more pegs 130 that are sized and dimensioned to fit within complementary holes or slots 132 on second pinion gear 128. This allows for internal knob 110 to rotate freely before engaging second pinion gear 128. Second pinion gear 128 is engaged by pegs 130 when those pegs interact with ends of slots 132.

Thus, as motor 120 turns, it causes pinion gear 124 to turn. Pinion gear 124 interacts with rack 126, which is a feature of locking blade 112, causing locking blade 112 to translate into either a locked or unlocked configuration in conjunction with locker receptacle 118. Each of these components can be at least partially disposed within handle enclosure 122.

FIGS. 3 and 4 show that second pinion gear 128 is configured to interact with second rack 134. Second rack 134 is disposed on a right side of locking blade 112 such that it does not run the entire length of the edge on which it is disposed. By having second rack 134 only disposed on a portion of the right edge of locking blade 112, second rack 134 can be disengaged from second pinion gear 128. This facilitates locking hatch lid 102 closed by pressing locking plunger 136 or actuating pinon gear 124. Because rack 134 becomes disengaged from second pinion gear 128, exterior handle 108 is disengaged, thereby preventing unwanted ingress. FIG. 3 shows second pinion gear 128 disengaged from second rack 134, while FIG. 4 shows second pinion gear 128 engaged with second rack 134. The locked configuration involves plunger 136 being depressed (FIG. 3) and the unlocked configuration (FIG. 4) involves the plunger 136 pulled out. Allowing for plunger 136 to lock and unlock system 100 manually can ensure hatch lid 102 can be both locked and unlocked in the event of power failure. Locking system 100 can also be put into a locked configuration by turning either exterior handle 108 or internal knob 110 until second pinion gear 128 disengages from second rack 134. Locking blade 112 features a slot that aspects of internal knob 110 and exterior handle 108 can pass through to allow locking blade to translate relative to those components without interference. In some embodiments, a small resistance can be added just prior to the mechanism being locked by adding, e.g., a small bump or resistance pad where second pinion gear 128 interacts with the end of the second rack 134.

Embodiments of the inventive subject matter can additionally include a reed switch 140. A reed switch is one that is actuated in the presence of a magnetic field. Reed switches can be made to be normally open, and thus in the presence of a magnetic field, such a reed switch could close, thereby completing a circuit. FIG. 5 shows a post which encloses the reed switch. The reed switch position can be calibrated for proper use inside the post before rigidly coupling the reed switch to the post. In locking system 100, for example, reed switch 140 is positioned within handle enclosure 122 such that, upon locking system 100 entering an unlocked configuration, magnet 142 is brought into close proximity with reed switch 140. When magnet 142 is in close proximity with reed switch 140, it causes reed switch 140 to close, which in turn allows for a signal indicating the locking system 100 is in the correct position for locking blade 112 to interact with locker receptacle 118. That signal can be interpreted by, e.g., a microcontroller, or it can be used to, e.g., activate a light source such as an LED. In some embodiments, the reed switch 140 and magnet 142 can additionally or alternatively be implemented to function as a limit switch or as a distance sensor as, e.g., an IR obstacle avoidance mechanism. Alternative configurations where magnet 142 is fixed to locking blade such that reed switch 140 is in the presence of a magnetic field when locking system 100 is in a locked (or unlocked) configuration are also contemplated.

One purpose of reed switch 140 is to indicate to the system when locking blade 112 is in the correct position to be inserted into locker receptacle 118. Magnet 142 is fixed to locker receptacle 118, and reed switch 140 is fixed to the handle enclosure 122. Reed switch 140 is activated as it moves towards magnet 142 as the hatch lid rotates. When reed switch 140 is active, it means locking blade 112 is positioned to properly translate into locker receptacle 118. Reed switch 140 can also act as a limit switch to indicate whether system 100 is locked or unlocked. Instead of a reed switch, limit switches, buttons, or other distance sensors can alternatively be implemented.

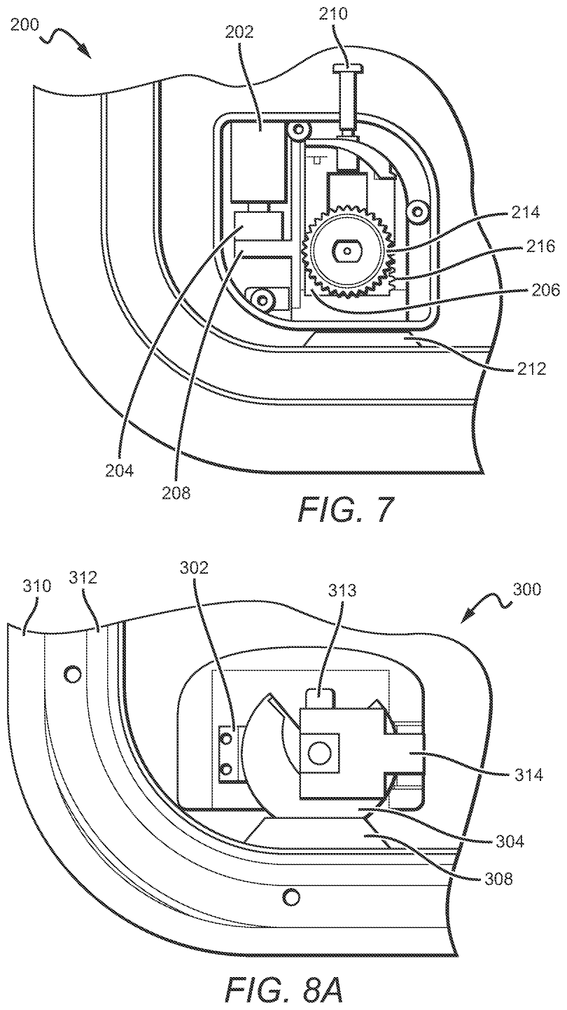

FIGS. 6 and 7 show another locking system 200 of the inventive subject matter. Locking system 200 implements a linear actuator 202 instead of a rotational one. Linear actuator 202 comprises an output shaft 204 that couples with locking blade 206. Locking blade 206 in locking system 200 is constructed largely the same as locking blade 112, except that instead of having rack 125, it features a protrusion 208, where protrusion 208 is coupled with output shaft 204. Because linear actuator 202 creates lateral movement, there is no need for a rack and pinion system as with locking system 100 to convert rotational movement into lateral movement. Thus, locking blade 206 can be the same as locking blade 112 in all other respects. Still in further embodiments, protrusion 208 is not included and locking blade 206 is configured to couple with output shaft 204.

By activating linear actuator 202, output shaft 204 presses against (or pulls on) protrusion 208. This causes locking blade 206 to translate (e.g., up or down as drawn in FIGS. 6 and 7), which in turn places locking system 200 into either a locked configuration (FIG. 6) or an unlocked configuration (FIG. 7). As with locking system 100, locking system 200 features a plunger 210 that can be used to place the system into either the locked or unlocked configuration by either engaging or disengaging locking blade 206 with locker receptacle 212. By fully depressing plunger 210, as shown in FIG. 6, pinion gear 214 becomes disengaged from rack 216 and locking blade 206 engages with locker receptacle 212. When plunger 210 is pulled out, as shown in FIG. 7, locking blade 206 disengages from locker receptacle 212 and pinion gear 214 is reengaged with rack 216. In still further embodiments, locker receptable 212 is not included and the locking blade 206 can interact directly with hatch base.

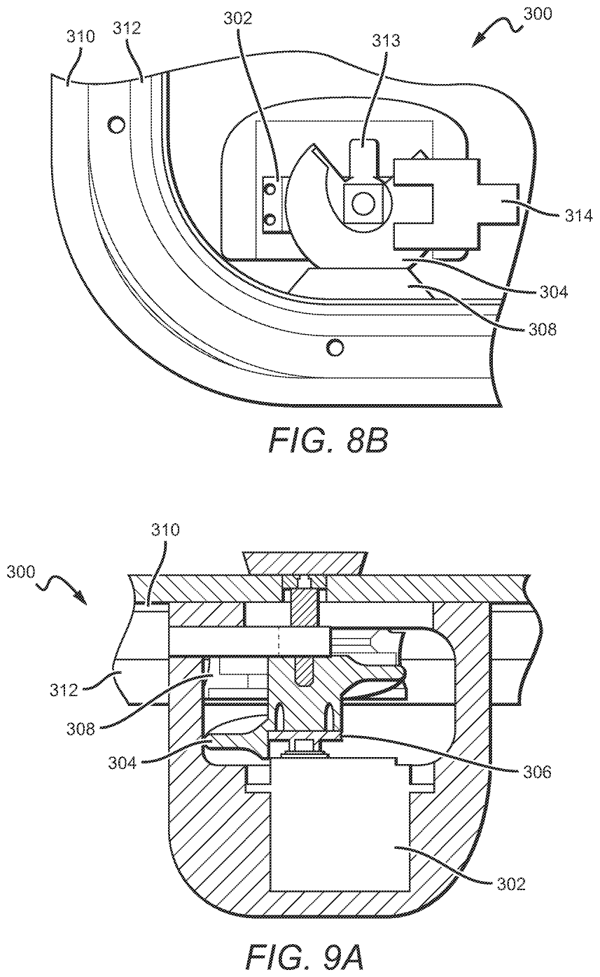

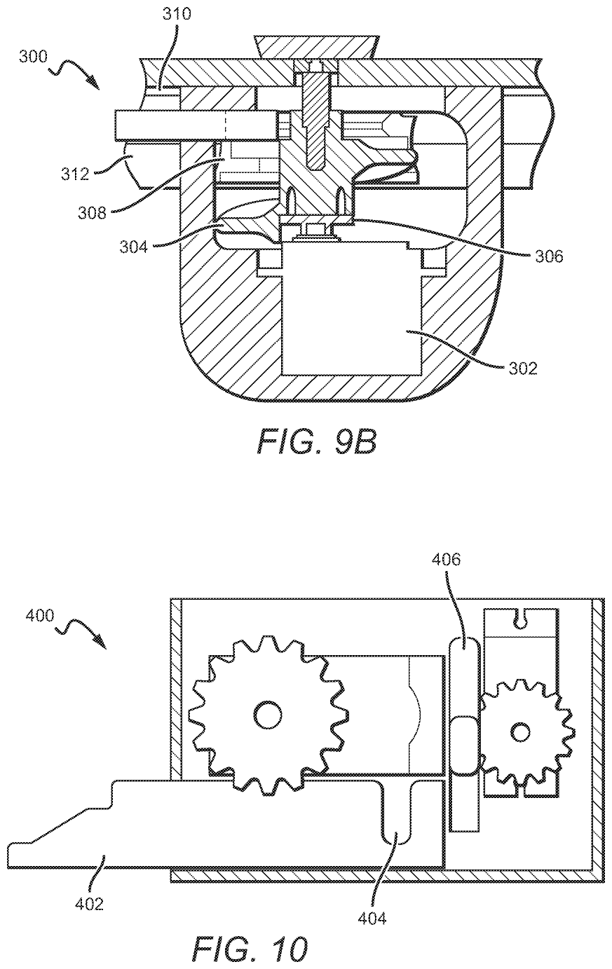

FIGS. 8 and 9 show an alternative locking system 300 that implements a rotational motor 302 coupled with a screw mechanism 304 by a gear linkage 306. When motor 302 turns, it causes screw mechanism 304 to rotate. Screw mechanism 304 interacts with locker receptacle 308 as it rotates, creating a reaction force that pulls hatch lid 310 down toward hatch base 312, which can improve weather and water proofing (e.g., it can create a seal between hatch lid and hatch base that prevents water from passing between the two components). As shown in FIG. 9, screw mechanism 304 features an angled surface disposed about a central axis, and as screw mechanism 304 rotates, it presses against locker receptacle 308. By turning screw mechanism 304 only partially once it has begun to interact with locker receptable 308, the system can enter a non-watertight locked configuration. As screw mechanism 304 turns further, it interacts with locker receptacle to pull hatch lid 310 down to hatch base 312 in a watertight and locked configuration. In still further embodiments, locker receptable 308 is not included and the locking blade 304 can interact directly with hatch base 312.

As shown in FIGS. 8A and 8B, screw mechanism 304 features a cutout portion. When screw mechanism 304 is rotated 180 degrees from its angular position shown in FIG. 8A, the cutout portion aligns with locker receptacle 308, bringing locking system 300 into an unlocked configuration. In the unlocked configuration, hatch lid 310 can lift up relative to hatch base 312. A manual tab 313 is used to manually rotate screw mechanism 304.

If, for example, there is a motor or electrical failure, screw mechanism 304 can be manually actuated by manual tab 313 as a backup to fully close a hatch, preventing situations where a hatch cannot be fully closed because of that failure. Screw mechanism 304 can also be manually actuated to open a hatch, especially during an evacuation situation when there is an electrical failure. Manual tab 313 is included on a side of the screw mechanism 304, giving users the ability to press against manual tab 313 to cause the screw mechanism 304 to rotate to fully close (e.g., lock) or open (e.g., unlock) the hatch. Manual tab 313 can thus be manually activated to prevent external operation of the locking system 300, thereby restricting unwanted access or creating a watertight seal of the hatch. In some embodiments, a hatch can have a single locking system 300, while in other embodiments two or more can be implemented.

In some embodiments, locking system 300 further comprises a manual locker 314, as shown in FIG. 8A-9B. Manual locker 314 has a square slot (or other convenient shape) that is configured to interact with a complementarily shaped portion on screw mechanism 304 such that manual locker 314, when slid into position with screw mechanism 304, prevents screw mechanism 304 from rotating. Manual lockers of the inventive subject matter can operate like, e.g., safety buckles or safety clips found on lifejackets. Manual tab 314 is shown in an unlocked position in FIGS. 8A and 9A, and in a locked position in FIGS. 8B and 9B.

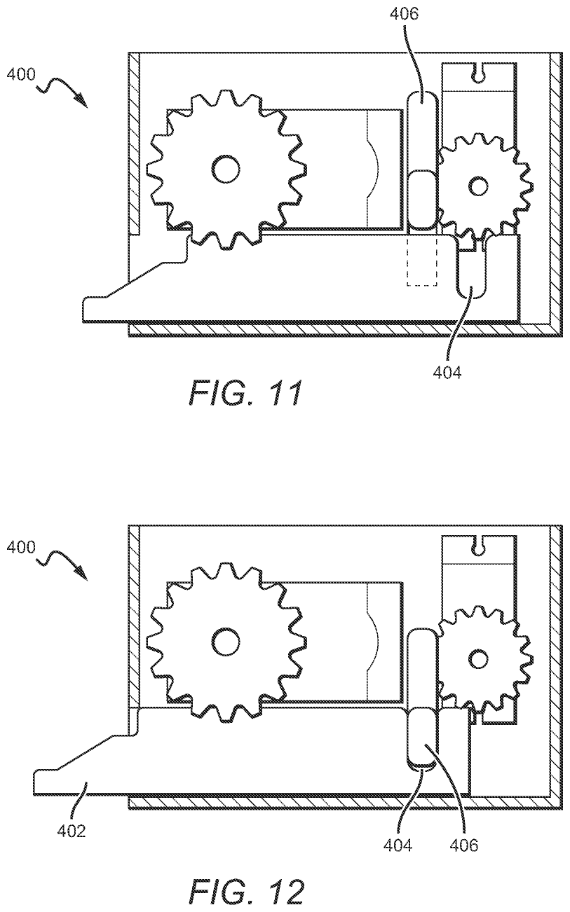

FIGS. 10 and 11 show another locking system 400 of the inventive subject matter that can be implemented in embodiments featuring a locking blade. Thus, locking system 400 incorporates a locking blade 402 that is configured to translate laterally (e.g., left to right as drawn). Locking blade 402 includes a slot 404 and locking system 400 additionally includes a locking tab 406. Locking tab 406 is sized and dimensioned to fit within slot 404 and locking tab 406 is configured to translate such that it can be positioned in slot 404. When locking tab 406 is positioned inside slot 404, the hatch lid will be partially open allowing minimal airflow whilst preventing unwanted ingress. Locking tab 406 can also be moved upward to allow locking blade to move freely from side to side. In some embodiments, locking tab 406 can be moved downward so that it is positioned behind the entirety of locking blade 402 when locking blade 402 is fully extended (e.g., pushed to the left as shown in FIG. 10). When locking tab 406 is positioned behind locking blade 402, it locks locking blade 402 into position, thereby holding locking system 400 in a locked configuration with a watertight seal. Locking tab 406 can be manually actuated using an exterior part of the locking tab or electronically actuated using a second actuator as shown.

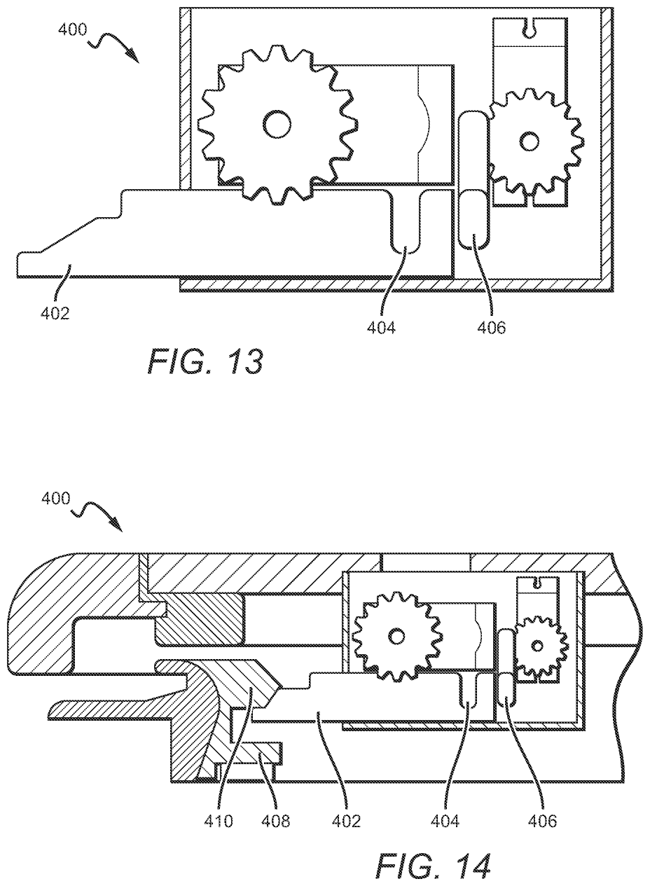

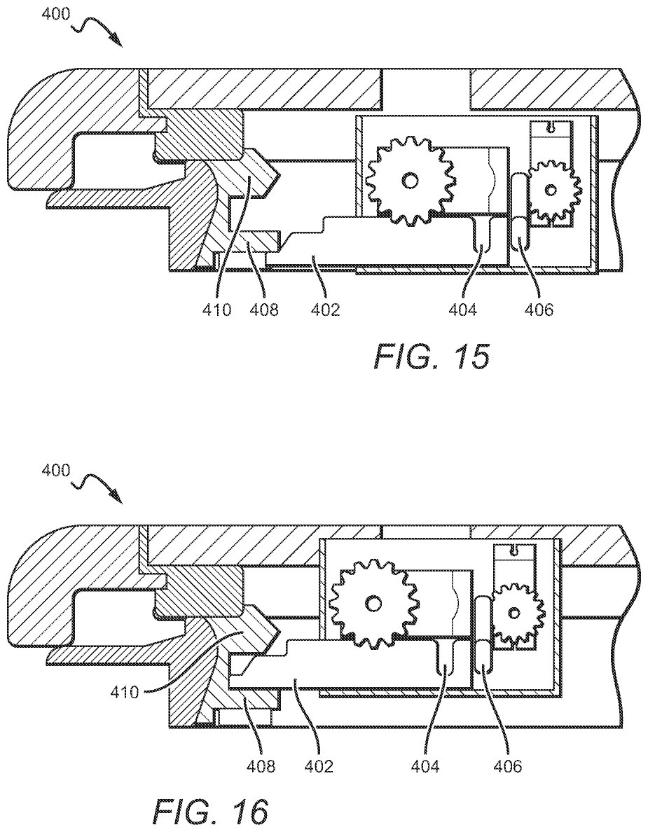

FIGS. 12 and 13 show locking system 400 in two different configurations. In FIG. 12, locking tab 406 is shown disposed in slot 404, while in FIG. 13 locking tab is positioned behind blade 402. FIGS. 14 through 16 show locking system 400 implemented into a hatch such that the hatch lid is non-watertight locked in FIG. 14 where blade 402 mates with an upper protrusion 410 of locker receptacle, watertight locked in FIG. 15 such that blade 402 mates with locker receptacle below a bottom protrusion 408, and FIG. 16 shows a different locked and watertight configuration wherein the blade 402 mates with locker receptacle's top protrusion such that the blade's sloped portion pulls hatch lid down to create a watertight seal.

Thus, specific systems and devices related to hatch locking/unlocking and opening/closing have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A lid locking and unlocking system comprising:
a locking mechanism configured to couple with the lid, the locking mechanism comprising:
a blade comprising a rack along an edge;
a motor coupled with a pinion gear, wherein the pinion gear is configured to interact with the rack such that rotating the pinion gear causes the blade to translate; and
a receiving mechanism configured to couple with a base, wherein the lid is hingedly coupled with the base and the receiving mechanism comprises a locker receptacle configured to receive the blade.

2. The locking system of claim 1, wherein the blade further comprises a second rack along a portion of a second edge of the blade.

3. The locking system of claim 2, further comprising an exterior manual actuator disposed on an exterior side of the lid, wherein the exterior manual actuator couples with a second pinion gear that is configured to interact with the second rack.

4. The locking system of claim 2, further comprising an interior manual actuator disposed on an interior side of the lid, wherein the interior manual actuator couples with a second pinion gear that is configured to interact with the second rack.

5. The locking system of claim 2, further comprising an exterior manual actuator disposed on an exterior side of the lid and an interior manual actuator disposed on an interior side of the lid, wherein the exterior manual actuator and the interior manual actuator both couple with a second pinion gear disposed therebetween, wherein the second pinion gear is configured to interact with the second rack.

6. The locking system of claim 5, wherein the second rack is disposed along a portion of the second edge of the blade such that the second pinion gear becomes disengaged from the second rack upon the locking mechanism entering a locked configuration.

7. The locking system of claim 4, wherein the interior manual actuator comprises at least one peg that is configured to interact with a slot disposed on a side of the second pinion gear facing the interior manual actuator.

8. The locking system of claim 1, wherein the blade comprises a plunger that can be used to manually translate the blade into and out of a locked configuration.

9. A lid locking and unlocking system comprising:
a locking mechanism configured to couple with the lid, the locking mechanism comprising:
a blade comprising a rack along an edge and a second rack along a second edge;
a motor coupled with a pinion gear, wherein the pinion gear is configured to interact with the rack such that rotating the pinion gear causes the blade to translate;
wherein the blade comprises a sloped portion on an end of the blade;
a receiving mechanism configured to couple with a base, wherein the lid is hingedly coupled with the base and the receiving mechanism comprises a locker receptacle configured to receive the sloped portion of the blade;
a manual actuation mechanism comprising:
an interior manual actuator disposed on an interior side of the lid, wherein the interior manual actuator couples with a second pinion gear that is configured to interact with the second rack; and
an exterior manual actuator disposed on an exterior side of the lid, wherein the exterior manual actuator also couples with the second pinion gear.

10. The locking system of claim 9, wherein the interior manual actuator comprises at least one peg that is configured to interact with a slot disposed on a side of the second pinion gear facing the interior manual actuator.

11. The locking system of claim 9, wherein the second rack is disposed along a portion of the second edge of the blade such that the second pinion gear becomes disengaged from the second rack upon the locking mechanism entering a locked configuration.

12. The locking system of claim 9, wherein the blade comprises a plunger that can be used to manually translate the blade into and out of a locked configuration.

13. The locking system of claim 9, wherein a locking tab is configured to restrict lateral movement of the blade.

14. A lid locking and unlocking system comprising:
a locking mechanism configured to couple with the lid, the locking mechanism comprising:
a blade;
a linear actuator coupled with the blade, wherein actuating the linear actuator causes the blade to translate; and
a receiving mechanism configured to couple with a base, wherein the lid is hingedly coupled with the base and the receiving mechanism comprises a locker receptacle is configured to receive the blade.

15. The locking system of claim 14, wherein the blade further comprises a rack along a portion of an edge of the blade.

16. The locking system of claim 15, further comprising an exterior manual actuator disposed on an exterior side of the lid, wherein the exterior manual actuator couples with a pinion gear that is configured to interact with the rack.

17. The locking system of claim 15, further comprising an interior manual actuator disposed on an interior side of the lid, wherein the interior manual actuator couples with a pinion gear that is configured to interact with the rack.

18. The locking system of claim 15, further comprising an exterior manual actuator disposed on an exterior side of the lid and an interior manual actuator disposed on an interior side of the lid, wherein the exterior manual actuator and the interior manual actuator both couple with a pinion gear disposed therebetween, wherein the pinion gear is configured to interact with the rack.

19. The locking system of claim 18, wherein the pinion gear becomes disengaged from the rack upon the locking mechanism entering a locked configuration.

20. The locking system of claim 17, wherein the interior manual actuator comprises at least one peg that is configured to interact with a slot or hole disposed on a side of the pinion gear facing the interior manual actuator.

21. The locking system of claim 14, wherein a locking tab is configured to restrict lateral movement of the blade.

22. A lid locking and unlocking system comprising:
a locking mechanism configured to couple with the lid, the locking mechanism comprising:
a screw mechanism;
a motor coupled with the screw mechanism, wherein actuating the motor causes the screw mechanism to rotate;
a receiving mechanism configured to couple with a base, wherein the lid is hingedly coupled with the base and the receiving mechanism comprises a locker receptacle configured to receive the screw mechanism.

23. The locking system of claim 22, further comprising an exterior manual actuator disposed on an exterior side of the lid, wherein the exterior manual actuator is configured to couple with the screw mechanism.

24. The locking system of claim 22, wherein a manual locker is configured to restrict lateral movement of the screw mechanism.
